(19) United States
(12) Patent Application Publication
(10) Pub. No.: US 2016/0346680 A1
(43) Pub. Date: Dec. 1, 2016

(54) GAME CONTROLLER WITH THUMBSTICK INTERFACE RING

(71) Applicant: Microsoft Technology Licensing, LLC, Redmond, WA (US)

(72) Inventors: Jason V. Tsai, Bellevue, WA (US); Aaron Schmitz, Redmond, WA (US); Benjamin M. Finney, Woodinville, WA (US); Gabriel M. R. Gassoway, Issaquah, WA (US)

(21) Appl. No.: 14/722,461

(22) Filed: May 27, 2015

(51) Int. Cl. A63F 13/24; B29C 65/48; B29C 65/08; B29C 70/76

(52) U.S. Cl. CPC A63F 13/24; B29C 70/76; B29C 65/48; B29C 65/08; B29K 2059/00

(57) ABSTRACT

A user input device is described that includes a ring that is connected to a housing of the user input device and that surrounds an aperture included in the housing from which a user-manipulable portion of a thumbstick extends. The ring serves to prohibit contact between a portion of the thumbstick and an edge of the housing that surrounds the aperture. The ring may be formed from a material that has a relatively low coefficient of friction with a material from which the portion of the thumbstick is formed. In certain embodiments, the ring may be removably connected to the housing of the game controller such that a user can easily disconnect and reconnect the ring to the housing without damaging either the ring or the housing.

### BACKGROUND

A game controller is a type of input device that is designed to facilitate user interaction with a video game or other application executing on a computer, video game console, or other platform. For example, a game controller may provide a means by which a user can control a character or object within a video game. A variety of different types of game controllers exist and each game controller type may include one or more user-actuatable control elements via which a user can provide input. For example, a conventional game controller that is designed to be held in two hands (sometimes referred to as a “gamepad,” “control pad,” or “joypad”) may include one or more user-actuatable buttons, triggers, thumbsticks, directional pads, touch pads, and the like. Each of these control elements may be manipulated by a user to generate various control signals for interacting with a video game or other application.

### SUMMARY

A user input device (e.g., a game controller) is described herein that includes a ring that is connected to a housing of the user input device and that surrounds an aperture included in the housing from which a user-manipulable portion of a thumbstick extends. The ring serves to prohibit contact between a portion of the thumbstick and an edge of the housing that surrounds the aperture. The ring may be formed from a material that has a relatively low coefficient of friction with a material from which the portion of the thumbstick is formed, thereby improving thumbstick responsiveness and decreasing wear. In certain embodiments, the ring may be removably connected to the housing of the game controller such that a user can easily disconnect and reconnect the ring to and from the housing without damaging either the ring or the housing. This enables users to customize their user input devices by selecting rings therefor that have various different aesthetic features and/or material properties. This also enables users to easily replace a ring without having to obtain special tools and without having to have the user input device serviced or replaced.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the claimed subject matter is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the application and, together with the description, further serve to explain the principles of the embodiments and to enable a person skilled in the relevant art(s) to make and use the embodiments.

FIG. 1 shows a cross-sectional view of a portion of a conventional game controller that includes a thumbstick.

FIG. 2 shows a perspective view of a game controller that includes two thumbstick interface rings in accordance with an embodiment.

FIG. 3 shows a top view of the game controller of FIG. 2.

FIG. 4 shows a cross-sectional view of the game controller of FIG. 2.

FIG. 5 shows an expanded view of a portion of the cross-sectional view shown in FIG. 4.

FIG. 6 shows an exploded view of a top case and the two thumbstick interface rings of the game controller of FIG. 2.

FIG. 7 shows a cross-sectional view of some of the game controller components shown in FIG. 6.

FIG. 8 shows a cross-sectional view of a portion of the game controller of FIG. 2 that illustrates a connection between a thumbstick interface ring and a top case thereof.

FIG. 9 shows an expanded view of a portion of the cross-sectional view shown in FIG. 8.

FIG. 10 shows an exploded view of a portion of a game controller for which a first heat stake method is used to connect a thumbstick interface ring to a housing of the game controller, in accordance with one embodiment.

FIG. 11 shows a cross-sectional view of some of the game controller components shown in FIG. 10.

FIG. 12 shows a cross-sectional view of a portion of the game controller of FIG. 10 that illustrates how a first heat stake method may be used to connect the thumbstick interface ring to the housing of the game controller.

FIG. 13 shows an expanded view of a portion of the cross-sectional view shown in FIG. 12.

FIG. 14 shows an exploded view of a portion of a game controller for which a second heat stake method is used to connect a thumbstick interface ring to a housing of the game controller, in accordance with one embodiment.

FIG. 15 shows a cross-sectional view of some of the game controller components shown in FIG. 14.

FIG. 16 shows a cross-sectional view of a portion of the game controller of FIG. 14 that illustrates how a second heat stake method may be used to connect the thumbstick interface ring to the housing of the game controller.

FIG. 17 shows an expanded view of a portion of the cross-sectional view shown in FIG. 16.

FIG. 18 shows a perspective cross-sectional view of a portion of a game controller in which a thumbstick interface ring is joined to a housing of the game controller via a two-shot injection molding process.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

A game controller is a type of input device that is designed to facilitate user interaction with a video game or other application executing on a computer, video game console, or other platform. For example, a game controller may provide a means by which a user can control a character or object within a video game. A variety of different types of game controllers exist and each game controller type may include one or more user-actuatable control elements via which a user can provide input. For example, a conventional game controller that is designed to be held in two hands (sometimes referred to as a “gamepad”, “control pad”, or “joypad”) may include one or more user-actuatable buttons, triggers, thumbsticks, directional pads, touch pads, and the like. Each of these control elements may be manipulated by a user to generate various control signals for interacting with a video game.

As noted above, some game controllers include at least one thumbstick. A thumbstick (which may also be referred to as an “analog thumbstick”, “analog stick”, “joystick,” “control stick,” or simply a “stick”) is a game controller component that can be manipulated by a user to generate two-dimensional input for controlling or otherwise interacting with a video game or other application.

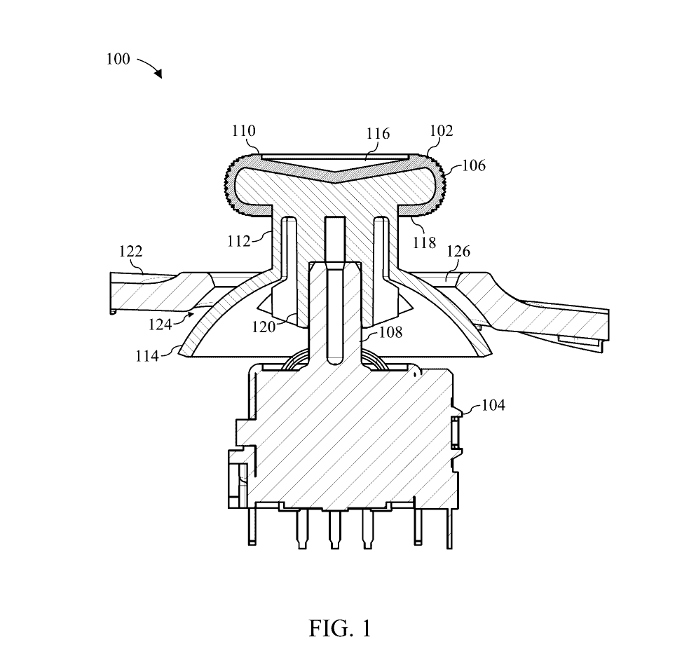

By way of example, FIG. 1 shows a cross-sectional view of a portion of a conventional game controller 100 that includes a thumbstick 102. Thumbstick 102 comprises a thumbstick module 104 and a thumbstick cap 106 that is attached thereto. Thumbstick module 104 is an electronic component that is mounted on a printed circuit board (not shown in FIG. 1) that is disposed within a housing of game controller 100. Thumbstick module 104 includes a moveable post 108 and a plurality of sensors in the form of potentiometers. The potentiometers utilize continuous electrical activity to generate an analog input control signal based on a position of moveable post 108 in relation to a default “center” position.

Thumbstick cap 106 comprises a generally disk-shaped top 110 that is connected to a dome-shaped base 114 via a cylindrical stem 112. Top 110 includes a first surface 116 and an opposing second surface 118. First surface 116 is designed to be manipulated by a user's finger (e.g., a user's thumb) and in this example is concave in shape. Thumbstick cap 106 also includes a connector 120 that extends perpendicularly from second surface 118 into a space defined by stem 112 and base 114. Connector 120 defines a cavity into which post 108 is inserted, thereby mounting thumbstick cap 106 on thumbstick module 104. By manipulating top 110 of thumbstick cap 106, a user can cause post 108 to deviate from its default “center” position, thereby generating a two-dimensional analog input control signal. Post 108 is biased such that when there is no force being applied, post 108 will revert to the default “center” position.

As further shown in FIG. 1, the housing of game controller 100 includes a top case 122. Top case 122 includes a generally conical or volcano-shaped portion that surrounds an aperture 124. Top 110 and stem 112 of thumbstick cap 106 extend outside of the housing of game controller 100 via aperture 124, and are thus accessible for user manipulation. A portion of base 114 of thumbstick cap 106 is also externally exposed via aperture 124. An edge 126 of top case 122 that surrounds aperture 124 limits the degree to which a user can displace thumbstick cap 106 in any given direction since, at a certain degree of displacement, stem 112 of thumbstick cap 106 will collide with edge 126. Dome-shaped base 114 of thumbstick cap 106 is sized such that, no matter what the degree or direction of displacement of thumbstick cap 106, the interior of the housing of game controller 100 will not be exposed via aperture 124.

In one conventional implementation, both the top case 122 of game controller 100 and thumbstick cap 106 are formed from a thermoplastic material, such as PC/ABS (a compounded blend of polycarbonate (PC) and acrylonitrile butadiene styrene (ABS)). PC/ABS is one of the most widely used industrial thermoplastics and has been found to be especially suitable for molded housings and parts that require high impact strength. The PC component of PC/ABS provides toughness while the ABS component helps make the material more moldable. In another conventional implementation, top case 122 of game controller 100 is formed from PC/ABS while thumbstick cap 106 is formed from ABS, which is typically less expensive than PC/ABS.

In each of these implementations, it has been observed that there is an undesirable degree of friction between thumbstick cap 106 and edge 126 of top case 122 when these components interact with each other (e.g., when a user moves thumbstick cap 106 such that stem 112 collides with and/or rubs up against edge 126). Such friction generates resistance that can impede the movement of thumbstick cap 106, thereby making thumbstick 102 less responsive to a user's manipulation thereof. This reduced responsiveness can be especially noticeable when the user is playing a video game that requires rapid and precise movement of thumbstick 102 in order to succeed at the game. In such situations, the reduced responsiveness caused by friction between stem 112 of thumbstick cap 106 and edge 126 can cause frustration on the part of the user.

Friction between thumbstick cap 106 and edge 126 can also cause increased wear on both components. For example, it has been observed that after long-term use of the aforementioned game controller implementations, friction between thumbstick cap 106 and edge 126 may wear a groove in stem 112 of thumbstick cap 106 as well as produce small flats in edge 126 of top case 122. These geometrical irregularities can cause the degree of friction between these components to increase, further reducing thumbstick responsiveness and increasing wear. Such wear can also detract from the aesthetic appearance of the game controller. The wearing away of edge 126 can also have the undesired effect of increasing the size of a zone in which the sensed displacement of the thumbstick beyond a maximum displacement is ignored (also known as the “dead zone”).

Embodiments described herein help address one or more of the foregoing issues. For example, embodiments described herein provide for a low-friction interface between a thumbstick and a housing of a user input device, such as a game controller. The low-friction interface may be achieved by disposing or attaching a ring around an aperture included in the housing of the user input device and via which the thumbstick extends from the housing of the user input device. The ring serves to prohibit contact between a portion of the thumbstick and an edge of the housing that surrounds the aperture. The ring may be formed from a material that has a relatively low coefficient of friction with a material from which the portion of the thumbstick is formed. As used herein and unless otherwise specified, the term “coefficient of friction” may refer to either a coefficient of static friction or a coefficient of kinetic friction. For example, in embodiments, the coefficient of friction between the material from which the ring is formed and the material from which the portion of the thumbstick is formed may be less than the coefficient of friction between the material from which the housing is formed and the material from which the portion of the thumbstick is formed. In certain embodiments, the coefficient of kinetic friction between the material from which the ring is formed and the material from which the portion of the thumbstick is formed is less than 0.4 per ASTM D1894.

By surrounding the thumbstick aperture with a ring that generates relatively low friction when a portion of the thumbstick comes into contact therewith, embodiments described herein can provide for improved thumbstick responsiveness as compared to certain conventional game controller embodiments (e.g., the conventional embodiments described above in which a PC/ABS or ABS thumbstick cap can come into contact with a PC/ABS housing) since there will be less friction to impede thumbstick movement. Furthermore, by surrounding the thumbstick aperture with such a low-friction ring, embodiments described herein can provide for reduced wear on the thumbstick and avoid any wear whatsoever on the edge of the housing that surrounds the thumbstick aperture.

An additional advantage associated with using the aforementioned low-friction ring to implement the thumbstick interface is that materials may be selected for the thumbstick interface that have properties that would not necessarily be suitable and/or desirable for use in forming the game controller housing. For example, in embodiments described herein, the ring may be formed from materials such as acetal or nylon that have a low coefficient of friction with respect to stainless steel and other thumbstick cap materials. However, acetal or nylon may not be ideal materials for forming the game controller housing (e.g., due to lack of strength, cosmetic appearance and/or cost). By using a ring to implement the thumbstick interface, the designer of the game controller is freed from having to find a single material that provides desirable properties for both the game controller housing and the thumbstick interface, or that provides a suitable tradeoff between such properties.

In certain embodiments described herein, the ring used to implement the thumbstick interface may be removably connected to the housing of the game controller. That is to say, a user can repeatedly connect the ring to the housing and disconnect the ring from the housing without damaging the ring or the housing. A variety of mechanisms for enabling such removable attachment are described herein including elastic snap-fit features, threaded fasteners, quarter turn hooks, and the like. Such embodiments advantageously enable users to customize their game controllers by selecting rings therefor that have various different aesthetic features and/or material properties. For example, rings may be selected that have different colors or shapes or that have different logos, images, text, or other designs formed thereon. A logo, image, text or other design may be formed on a ring via molding, printing, etching, engraving, stamping, or other suitable technique. As another example, rings may be selected that have different frictional properties as certain users may prefer more friction at the ring/thumbstick interface than others. Furthermore, because the ring may be easily attached and removed from the game controller, if a ring were to become worn or damaged, the user could easily replace the ring without having to obtain special tools and without having to have the game controller serviced or replaced.

A further benefit associated with the use of a removably-connectable ring to implement the thumbstick interface is that no masking fixture is required to prevent paint from being deposited on the edge of the thumbstick aperture during manufacturing. In certain conventional game controller implementations, the presence of paint on the thumbstick interface edge (e.g., edge 126) creates problems such as stickiness and visible wear. In accordance with certain embodiments described herein, any paint deposited on the edge of the thumbstick aperture will be covered by the subsequently-installed ring, thereby obviating the need for a masking fixture during the painting of the game controller surface.

In the following sections, various embodiments of a user input device that includes a thumbstick interface ring will be more fully described. In particular, Section II describes various example game controllers and thumbstick interface rings that may be connected thereto. Section III describes some additional exemplary embodiments. Section IV provides some concluding remarks.

### II. Example Game Controllers and Thumbstick Interface Rings that May be Connected Thereto

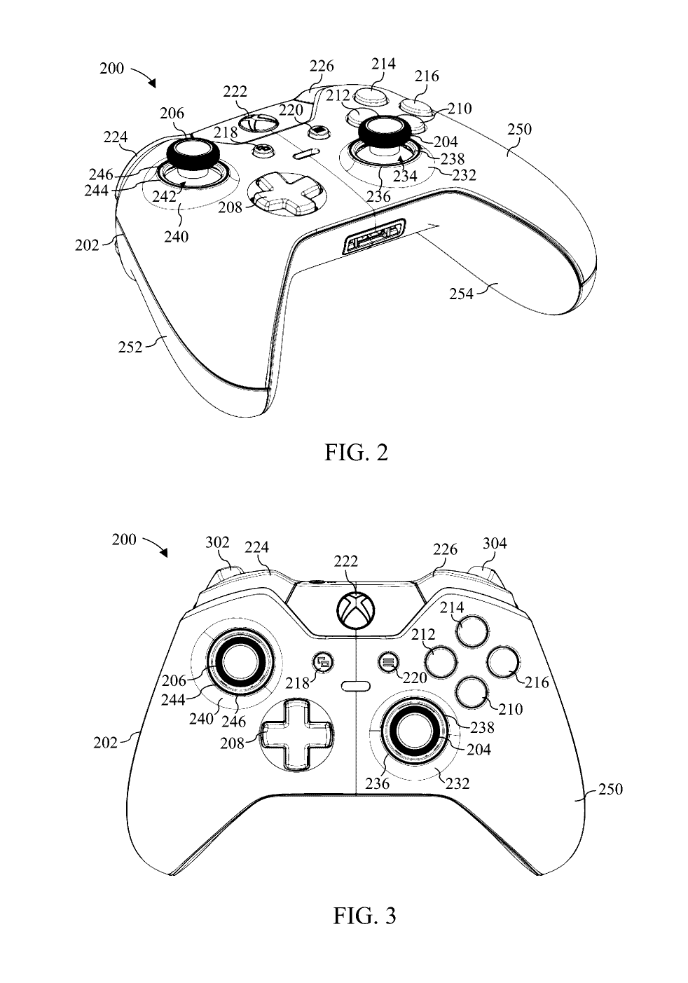

FIG. 2 shows a perspective view of an example game controller 200 that includes two thumbstick interface rings in accordance with an embodiment. FIG. 3 shows a top view of game controller 200. As shown in these figures, game controller 200 comprises a housing 202 that includes a number of mechanically interconnected components, including a top case 250, a bottom case 252 and a bottom trim component 254, that together define a cavity in which various internal components of game controller 200 are disposed. In an embodiment, each of the aforementioned components of housing 202 is formed from a thermoplastic material, such as PC/ABS. As was noted above, PC/ABS is one of the most widely used industrial thermoplastics and has been found to be especially suitable for molded housings and parts that require high impact strength. However, this example is not intended to be limiting, and the components of housing 202 may be formed from other materials as well.

Housing 202 includes a plurality of apertures via which various user-actuatable control elements of game controller 200 are exposed to and rendered manipulable by a user. The user-actuatable control elements of game controller 200 include a right thumbstick 204, a left thumbstick 206, a directional pad (D-pad) 208, a plurality of face buttons 210, 212, 214, 216, 218, 220 and 222, a left bumper button 224, a right bumper button 226, a left trigger 302, and a right trigger 304. Generally speaking, each of these user-actuatable control elements is connected to one or more sensors disposed within game controller 200. Such sensor(s) operate to detect when a user has interacted with a particular user-actuatable control element. Electronic circuitry disposed within game controller 200 operates to convert data generated by such sensors into user input control signals that may then be transmitted via a wired or wireless communication medium to a computer, game console, or other platform, where such user input control signals may be used to control a video game or other application. In embodiments, some or all of the aforementioned sensors and electronic circuitry are disposed on a printed circuit board that is disposed internal to housing 202.

Right thumbstick 204 extends from top case 250 via an aperture 234 defined therein. Aperture 234 is surrounded by an edge 236 and a generally conical or volcano-shaped portion 232 of top case 250. A ring 238 is connected to top case 250 such that it also surrounds aperture 234 and substantially covers edge 236. During user manipulation of right thumbstick 204, ring 238 limits the degree to which a user can displace right thumbstick 204 in any direction since, at a certain degree of displacement, a stem of right thumbstick 204 will collide with ring 238. Ring 238 further serves to impede contact between right thumbstick 204 and edge 236.

In an embodiment, ring 238 is formed from a material that has a relatively low coefficient of friction with a material from which the stem of right thumbstick 204 is formed. For example, in an embodiment, the coefficient of friction between the material from which ring 238 is formed and the material from which the stem of right thumbstick 204 is formed is less than the coefficient of friction between the material from which top case 250 is formed and the material from which the stem of right thumbstick 204 is formed. In certain embodiments, the coefficient of kinetic friction between the material from which ring 238 is formed and the material from which the stem of right thumbstick 204 is formed is less than 0.4 per ASTM D1894. In certain embodiments, a wear factor between the material from which ring 238 is formed and the material from which the stem of right thumbstick 204 is formed is less than 200 (mm³/N m)10⁻⁸ tested per thrust washer ASTM D3702.

In some embodiments, ring 238 is formed from a semicrystalline thermoplastic such as acetal (e.g., DELRIN® acetal resin, sold by E. I. du Pont de Nemours and Company of Wilmington, Del.) and the portion of right thumbstick 204 that can come into contact therewith is formed from stainless steel, aluminum, steel, or other suitable metal. The acetal may be combined with one or more additives to enhance the low-friction properties thereof, such as TEFLON®, PTFE, or silicon. In an alternate embodiment, ring 238 is formed from nylon, with or without additives that may enhance the low-friction properties thereof. Other materials that may be used to form ring 238 include but are by no means limited to RULON® or RULON® J (sold by Saint-Gobain Corporation of Courbevoie, Ile-de-France) and PEEK (polyether ether ketone). In alternative embodiments, ring 238 is formed from metal and the portion of right thumbstick 204 that interacts therewith is formed from plastic. In still further embodiments, a surface of ring 238 and/or a surface of the portion of right thumbstick 204 that interacts with ring 238 may be polished or given any other appropriate texture to better control friction and wear.

Of course, any of a wide variety of ring and thumbstick material combinations may be used to achieve a desired coefficient of friction and/or wear factor. The ring and thumbstick may even be made of the same material if this achieves a desired coefficient of friction and/or wear factor. As noted above, by implementing a ring/thumbstick interface with a relatively low coefficient of friction and/or wear factor, embodiments described herein can advantageously achieve improved thumbstick responsiveness and reduced wear as compared to certain conventional game controller designs. Moreover, by utilizing ring 238 to interface with right thumbstick 204 (as opposed to utilizing edge 236 of top case 250 to interface with right thumbstick 204), a material can be selected for manufacturing ring 238 that would not necessarily be suitable and/or desirable for manufacturing top case 250. For example, although acetal or nylon may not be deemed ideal materials for top case 250, e.g., due to lack of strength, cosmetic appearance and/or cost, such materials may nevertheless be selected for ring 238 due to their frictional and/or wear properties when interacting with right thumbstick 204.

A ring 246 is also connected to top case 250 and serves as an interface with left thumbstick 206. In particular, left thumbstick 206 extends from top case 250 via an aperture 242 defined therein. Aperture 242 is surrounded by an edge 244 and a generally conical or volcano-shaped portion 240 of top case 250. Ring 246 is connected to top case 250 such that it also surrounds aperture 242 and substantially covers edge 244. During user manipulation of left thumbstick 206, ring 246 limits the degree to which a user can displace left thumbstick 206 in any direction since, at a certain degree of displacement, a stem of left thumbstick 206 will collide with ring 246. Ring 246 further serves to impede contact between left thumbstick 206 and edge 244.

Ring 246 may be formed using any of the materials discussed above in reference to ring 238. The stem of left thumbstick 206 that can come into contact with ring 246 may be formed from any of the materials discussed above in reference to the stem of right thumbstick 204. Again, a wide variety of ring and thumbstick material combinations may be used to achieve a desired coefficient of friction and/or wear factor and to achieve various advantages over certain conventional game controller designs as discussed above.

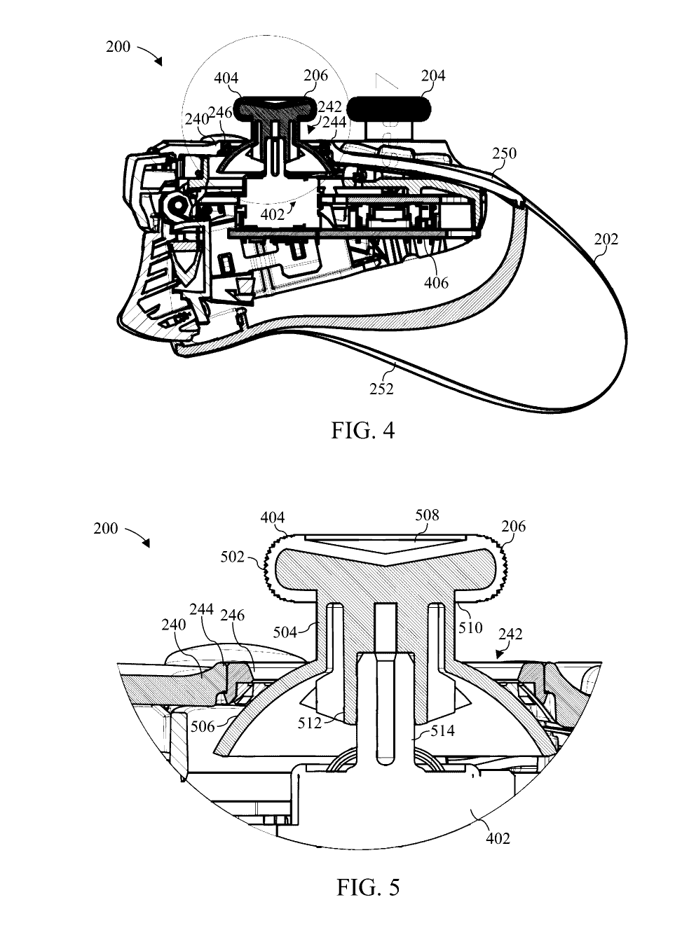

FIG. 4 shows a cross-sectional view of game controller 200 that reveals additional features thereof. FIG. 5 provides an expanded view of a portion of the cross-sectional view shown in FIG. 4. As shown in these figures, left thumbstick 206 comprises a thumbstick module 402 and a thumbstick cap 404 that is attached thereto. Thumbstick module 402 is an electronic component that is mounted on a printed circuit board 406 that is disposed within housing 202 of game controller 200. Thumbstick module 402 includes a moveable post 514 and a plurality of sensors in the form of potentiometers. The potentiometers utilize continuous electrical activity to generate an analog input control signal based on a position of moveable post 514 in relation to a default “center” position.

Thumbstick cap 404 comprises a generally disk-shaped top 502 that is connected to a dome-shaped base 506 via a cylindrical stem 504. Top 502 includes a first surface 508 and an opposing second surface 510. First surface 508 is designed to be manipulated by a user's finger (e.g., a user's thumb) and in this example is concave in shape. Thumbstick cap 404 also includes a connector 512 that extends perpendicularly from second surface 510 into a space defined by stem 504 and base 506. Connector 512 defines a cavity into which post 514 is inserted, thereby mounting thumbstick cap 404 on thumbstick module 402.

Thumbstick cap 404 extends from the internal cavity defined by housing 202 and outside housing 202 via aperture 242. By manipulating top 502 of thumbstick cap 404, a user can cause post 514 to deviate from its default “center” position, thereby generating a two-dimensional analog input control signal. Post 514 is biased such that when there is no force being applied, post 514 will revert to the default “center” position. Dome-shaped base 506 of thumbstick cap 404 is sized such that, no matter what the degree or direction of displacement of thumbstick cap 404, the interior of housing 202 of game controller 200 will not be exposed via aperture 242. Ring 246 limits the range of movement of left thumbstick 206 because at a certain degree of displacement, thumbstick cap 404 will collide with ring 246.

Right thumbstick 204 may be implemented using a thumbstick module and a thumbstick cap that are substantially similar to thumbstick module 402 and thumbstick cap 404 shown in FIGS. 4 and 5.

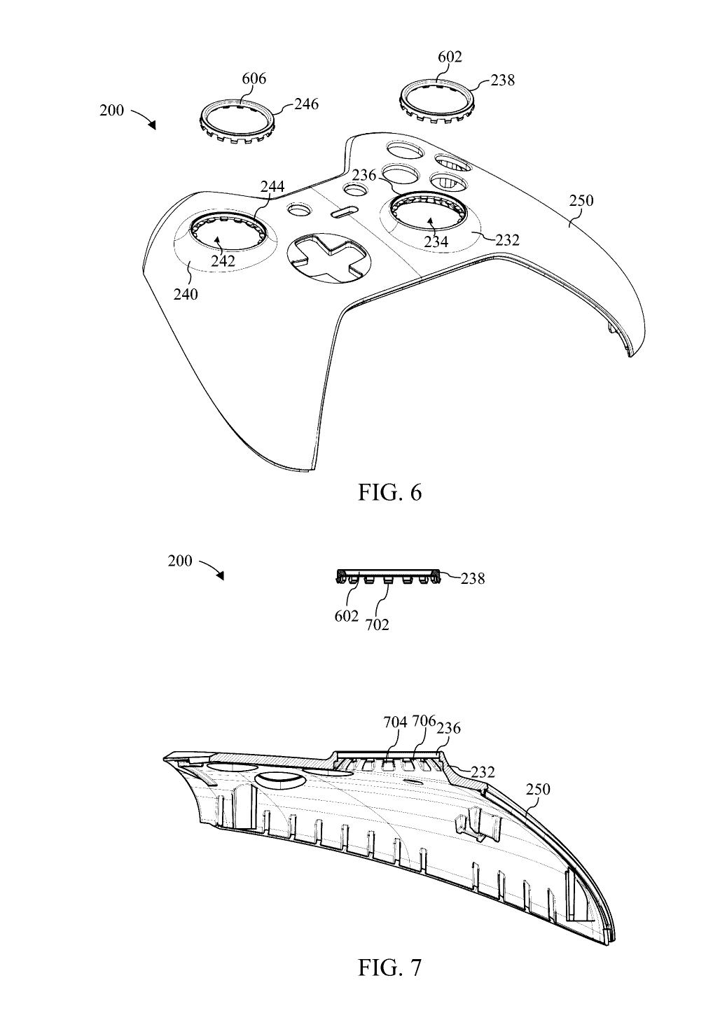

Game controller 200 represents an example embodiment in which the rings that surround the thumbstick apertures (also referred to herein as “thumbstick interface rings”) are removably connected to the game controller housing. That is to say, ring 238 and ring 246 of game controller 200 are each removably connected to top case 250 such that a user can repeatedly connect and disconnect each of the rings to and from top cover 250, without damaging the rings or the top cover 250. A variety of mechanisms may be used for enabling such removable attachment. In the embodiment represented by game controller 200, an elastic snap-fit attachment based on cantilever hooks is used. To help illustrate this form of attachment, FIG. 6 shows an exploded view of a portion of game controller 200. In particular, FIG. 6 provides an exploded view of top case 250, ring 238 and ring 246 of game controller 200. FIG. 7 provides a cross-sectional view of some of the components shown in FIG. 6.

As shown in FIGS. 6 and 7, ring 238 comprises a ring-shaped body 602 that surrounds or defines an opening. Body 602 is sized to fit closely within a space defined by edge 236 of top case 250 around aperture 234. Ring 238 also comprises a plurality of first mating elements that are connected to and project from body 602. A representative first mating element 702 is shown in FIG. 7. In this particular embodiment, a total of 16 substantially similar first mating elements are connected to and project from body 602. In alternate embodiments, a different number of first mating elements may be used. Each first mating element comprises an elastic beam with a prism-shaped head located at its free end, and may be referred to as a “hook”. The beam portion of each first mating element is integral to body 602 at its root.

For each first mating element of ring 238, top case 250 includes a corresponding second mating element in the form of a recess below edge 236 of the portion of top case 250 that surrounds aperture 234. Each first mating element of ring 238 may be removably connected to a corresponding second mating element. A representative second mating element 704 is shown in FIG. 7. In this particular embodiment, a total of 16 substantially similar second mating elements are included below edge 236 of top case 250. In alternate embodiments, a different number of second mating elements may be used. Between each second mating element, a ledge element of top case 250 projects from below edge 236 toward a center of aperture 234. A representative ledge element 706 is shown in FIG. 7. In this particular embodiment, a total of 16 substantially similar ledge elements project from below edge 236 toward the center of aperture 234. In alternate embodiments, a different number of ledge elements may be used.

Similarly, ring 246 comprises a ring-shaped body 606 that surrounds or defines an opening. Body 606 is sized to fit closely within a space defined by edge 244 of top case 250 around aperture 242. Ring 246 also includes a plurality of first mating elements that are connected to and project from body 606. In this particular embodiment, a total of 16 substantially similar first mating elements are connected to and project from body 606. In alternate embodiments, a different number of first mating elements may be used. Each first mating element comprises an elastic beam with a prism-shaped head located at its free end, and may be referred to as a “hook”. The beam portion of each first mating element is integral to body 606 at its root.

For each first mating element of ring 246, top case 250 includes a corresponding second mating element in the form of a recess below edge 244 of the portion of top case 250 that surrounds aperture 242. Each first mating element of ring 246 may be removably connected to a corresponding second mating element. In this particular embodiment, a total of 16 substantially similar second mating elements are included below edge 244 of top case 250. In alternate embodiments, a different number of second mating elements may be used. Between each second mating element, a ledge element of top case 250 projects from below edge 244 toward a center of aperture 242. In this particular embodiment, a total of 16 substantially similar ledge elements project from below edge 244 toward the center of aperture 242. In alternate embodiments, a different number of ledge elements may be used.

To connect ring 238 to top case 250, ring 238 may be placed over aperture 234 such that the first mating elements extending from body 602 of ring 238 are aligned with the second mating elements formed below edge 236 of top case 250. After this, downward pressure may be applied to ring 238 (i.e., pressure toward the internal cavity of game controller 200). Such downward pressure will cause each of the first mating elements to elastically deflect away from edge 236 toward the center of aperture 234. Once the prism-shaped heads of the first mating elements clear edge 236, they will recover their original shape, thereby snapping into the recesses below edge 236 that form the second mating elements. The ledge elements that project from between each of the recesses will catch body 602 of ring 238 so that it cannot descend any further into the internal cavity of game controller 200 via aperture 242. Since the ledges pull body 602 of ring 238 upward while the recesses pull the first mating elements connected to body 602 of ring 238 downward, ring 238 will be locked firmly in place.

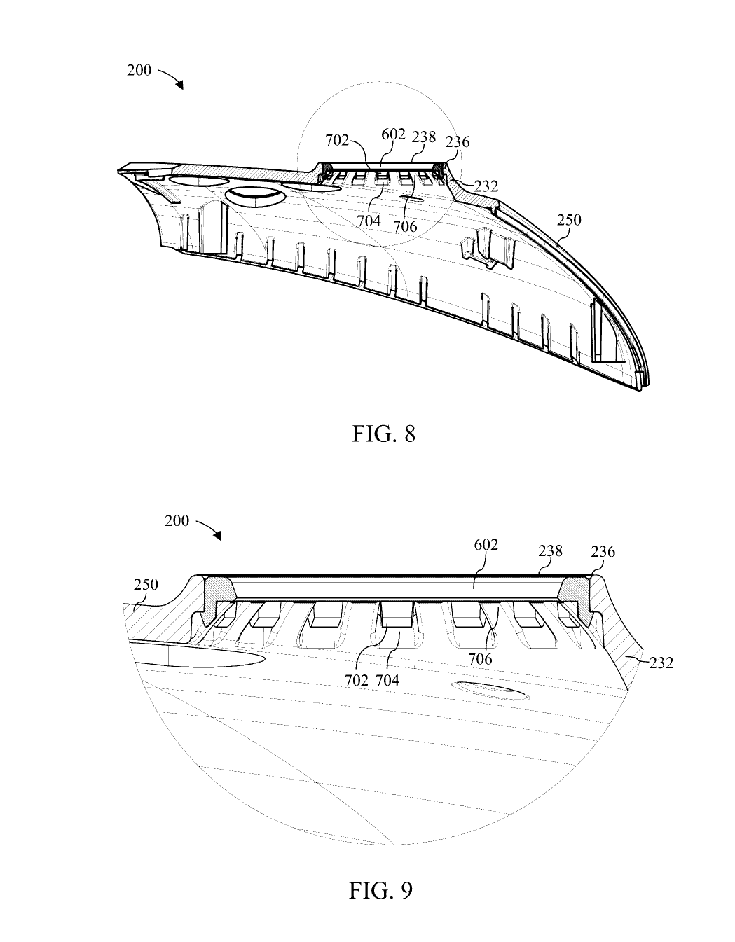

FIG. 8 shows a cross-sectional view of a portion of game controller 200 that illustrates the connection between ring 238 and top case 250 after ring 238 has been installed in the manner described above. FIG. 9 shows an expanded view of a portion of the cross-sectional view shown in FIG. 8. As shown in these figures, after ring 238 has been snapped into top case 250, body 602 of ring 238 is held in place by the ledges below edge 236 (e.g., ledge 706) such that ring 238 cannot descend any further into the internal cavity of game controller 200. Furthermore, the prism-shaped head of each first mating elements (e.g., first mating element 702) is caught in a corresponding recess (e.g., second mating element 704) formed below edge 236 of top case 250, such that ring 238 cannot be removed from top case 250 without a user applying some amount of pressure to do so. Accordingly, it can be expected that ring 238 will not fall out of its position during normal use of controller 200.

In an embodiment, a user can remove ring 238 after it has been installed in the manner described above by simply using a fingertip, fingernail, the tip of a flat-head screwdriver, or some other suitable object to apply upward pressure (pressure directed away from the internal cavity of game controller 200) on body 602 of ring 238.

It is to be understood that like methods to those described above can be used to attach ring 246 to housing 250 of game controller 200 and to remove it therefrom.

The foregoing elastic snap-fit attachment mechanism based on cantilever hooks comprises merely one way in which a thumbstick interface ring may be removably connected to the housing of a game controller. For example, in accordance with other embodiments, other types of elastic snap-fit attachment mechanisms may be used, including but not limited to: window snaps, annular snaps, leaf-spring snaps, ball-and-socket snaps, post-and-dome snaps, compression hooks, compression traps and beams, bayonet-finger snaps and torsion snaps.

In another embodiment, an attachment method based on threaded fasteners is used to removably connect a thumbstick interface ring to the housing of a game controller. In accordance with such an embodiment, the thumbstick interface ring may comprise a ring-shaped body that surrounds or defines an opening (similar to body 602 of ring 238) and a first mating element that is connected to the body. The first mating element may comprise a threaded ring having a first surface that faces toward the opening defined by the ring-shaped body and an opposing surface that faces away from the opening, wherein the opposing surface is a first threaded surface. The housing of the game controller may include a second mating element that comprises a threaded socket. Such threaded socket may comprise a second threaded surface formed around the edge of an aperture via which a thumbstick extends from an internal cavity of the game controller. The threaded ring may be removably connected to the threaded socket by twisting the threaded ring into the threaded socket, thereby causing the first threaded surface to mate with the second threaded surface. This has the effect of removably connecting the thumbstick interface ring to the housing of the game controller.

In yet another embodiment, an attachment method based on quarter turn hooks is used to removably connect a thumbstick interface ring to the housing of a game controller. In accordance with such an embodiment, the thumbstick interface ring may comprise a ring-shaped body that surrounds or defines an opening (similar to body 602 of ring 238) and a first mating element that is connected to the body. The first mating element may comprise a quarter-turn fastener. The housing of the game controller may include a mating socket for the quarter-turn fastener. Such mating socket may be formed around the edge of an aperture via which a thumbstick extends from an internal cavity of the game controller. The quarter-turn fastener may be removably connected to the mating socket by inserting it into the mating socket and then turning it 90 degrees in either a clockwise or counterclockwise direction depending upon the implementation. This has the effect of removably connecting the thumbstick interface ring to the housing of the game controller.

In still further embodiments, an interference or press fit mechanism may be used to removably connect a thumbstick interface ring to the housing of a game controller. As will be appreciated by persons skilled in the relevant art(s), such a mechanism achieves fastening between the thumbstick interface ring and the housing of the game controller by ensuring that there is friction between the two components after the two parts are pushed together.

The aforementioned mechanisms for removably connecting a thumbstick interface ring to the housing of a game controller have been described herein by way of example only are not intended to be limiting. Persons skilled in the relevant art will readily appreciate that a wide variety of other mechanisms may be used to implement such removable attachment.

The foregoing embodiments in which the thumbstick interface ring is removably connectable to the game controller housing advantageously enable users to customize their game controllers by selecting rings therefor that have various different aesthetic features and/or material properties. For example, rings may be selected that have different colors or shapes or that have different logos, images, text, or other designs formed thereon. A logo, image, text or other design may be formed on a ring via molding, printing, etching, engraving, stamping, or other suitable technique. As another example, rings may be selected that have different frictional properties as certain users may prefer more friction at the ring/thumbstick interface than others. Furthermore, because the ring may be easily attached and removed from the game controller, if a ring were to become worn or damaged, the user could easily replace the ring without having to obtain special tools and without having to have the game controller serviced or replaced.

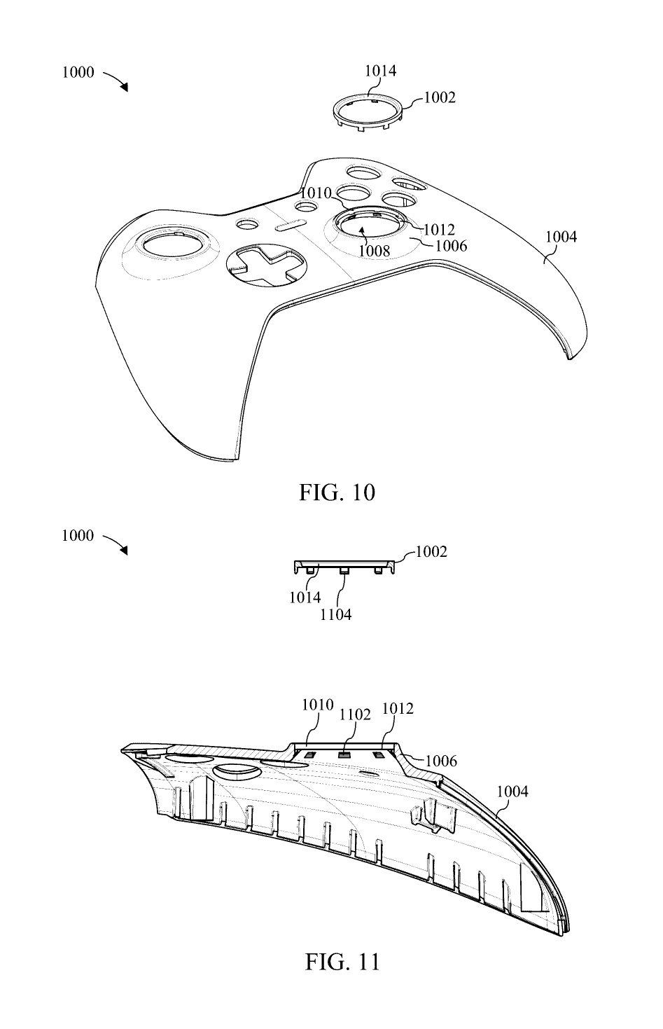

In alternate embodiments, a more permanent method of attaching a thumbstick interface ring to the housing of a game controller may be used. Such method may prohibit easy user removal of the ring by the user. For example, FIG. 10 shows an exploded view of a portion of a game controller 1000 for which a first heat stake method is used to connect a thumbstick interface ring 1002 to a housing of game controller 1000. With the exception of the manner in which thumbstick interface ring 1002 is connected to the housing of game controller 1000, game controller 1000 may have a substantially similar design to game controller 200 as described above in reference to FIGS. 2-9. FIG. 11 shows a cross-sectional view of some of the game controller components shown in FIG. 10.

As shown in FIGS. 10 and 11, the housing of game controller 1000 includes a top case 1004. Top case 1004 includes an aperture 1008 defined therein, via which a thumbstick may extend from an internal cavity of game controller 1000. Aperture 1008 is surrounded by an edge 1010 and a generally conical or volcano-shaped portion 1006 of top case 1004. Top case 1004 also includes a circular ledge element 1012 that projects from below edge 1010 toward a center of aperture 1008. Circular ledge element 1012 has a top surface that faces away from an internal cavity of game controller 1000 and a bottom surface that faces toward the internal cavity of game controller 1000. Circular ledge element 1012 includes a plurality of holes formed therein, wherein each of the holes extends from the top surface to the bottom surface. A representative hole 1102 is shown in FIG. 11. In this particular embodiment, a total of 8 substantially similar holes are formed in circular ledge element 1012. In alternate embodiments, a different number of holes may be used.

As further shown in FIGS. 10 and 11, thumbstick interface ring 1002 comprises a ring-shaped body 1014 that surrounds or defines an opening. Body 1014 is sized to fit closely within a space defined by edge 1010 of top case 1004 around aperture 1008. Ring 1002 also comprises a plurality of studs that are connected to and project from body 1014. A representative stud 1104 is shown in FIG. 11. In this particular embodiment, a total of 8 substantially similar studs are connected to and project from body 1014. In alternate embodiments, a different number of studs may be used.

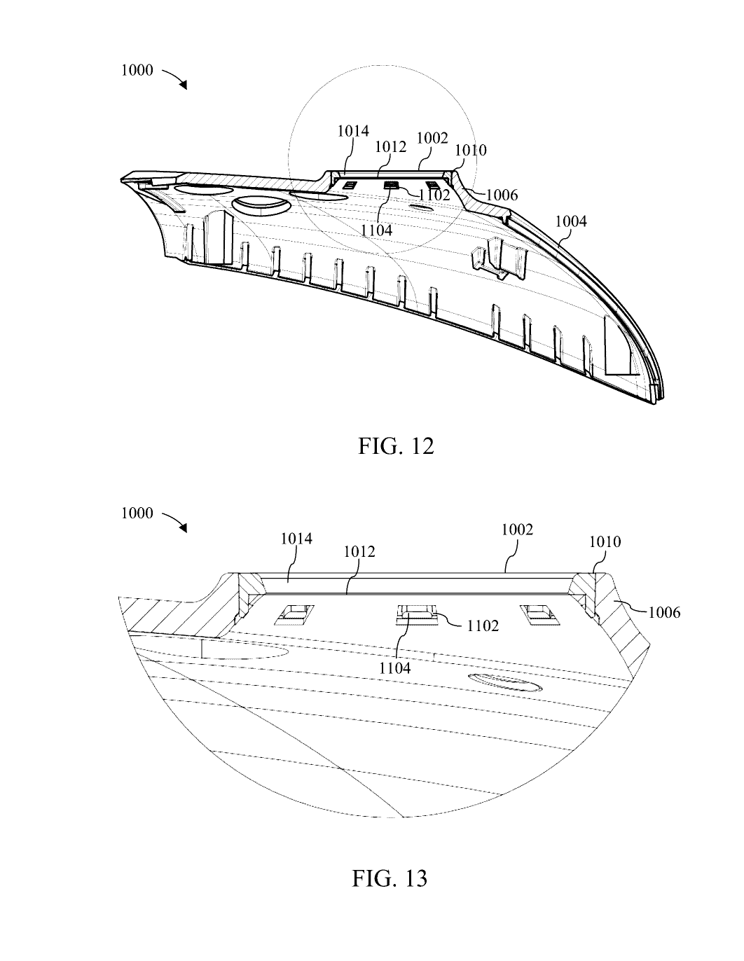

During manufacturing, ring 1002 is placed over aperture 1008 such that the studs extending from body 1014 of ring 1002 are aligned with the holes in circular ledge element 1012 formed below edge 1010 of top case 1004. After this, downward pressure is applied to ring 1002. Such downward pressure causes each of the studs to slide into a corresponding one of the holes disposed in circular ledge component 1012, while body 1014 comes to rest on circular ledge component 1012 such that it cannot descend further into the internal cavity of game controller 1000. This configuration is shown in FIG. 12, which shows a cross-sectional view of a portion of game controller 1000, and in FIG. 13, which shows an expanded view of a portion of the cross-sectional view of FIG. 12.

When body 1014 of ring 1002 is resting on circular ledge component 1012, an end of each stud connected to body 1014 extends through a corresponding hole formed in circular ledge component 1012 so that it is exposed at the bottom surface thereof. For example, as can be seen in FIGS. 12 and 13, an end of stud 1104 extends through hole 1102 so that it is exposed at the bottom surface of circular ledge component 1012. When such a configuration has been achieved, heat may then applied to the exposed end of each stud. Such heat may be applied, for example, by applying a heated thermal tip of a heat staking machine to the exposed end of each stud. It is assumed for the purposes of this embodiment that the studs are formed from plastic. The application of heat to the ends of the plastic studs increases the malleability of the ends of the plastic studs. A mechanical force is applied to the heated ends that causes each end to deform to form a head. The head that is formed on each stud is wider than the hole through which the stud has been fitted. When the heads cool, they serve to mechanically lock ring 1002 to top case 1004.

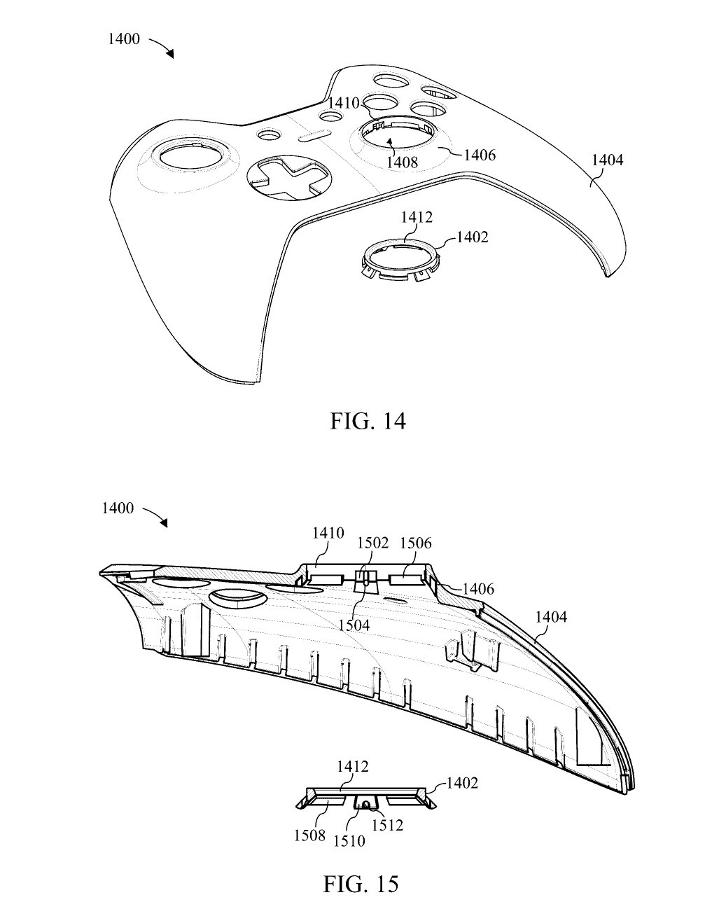

An embodiment that utilizes an alternate heat stake method to connect a thumbstick interface ring to a housing of a game controller will now be described. In particular, FIG. 14 shows an exploded view of a portion of a game controller 1400 for which a second heat stake method is used to connect a thumbstick interface ring 1402 to a housing of game controller 1400. With the exception of the manner in which thumbstick interface ring 1402 is connected to the housing of game controller 1400, game controller 1400 may have a substantially similar design to game controller 200 as described above in reference to FIGS. 2-9. FIG. 15 shows a cross-sectional view of some of the game controller components shown in FIG. 14.

As shown in FIGS. 14 and 15, the housing of game controller 1400 includes a top case 1404. Top case 1404 includes an aperture 1408 defined therein, via which a thumbstick may extend from an internal cavity of game controller 1400. Aperture 1408 is surrounded by an edge 1410 and a generally conical or volcano-shaped portion 1406 of top case 1404. Top case 1404 also includes a plurality of first recesses, each of which is formed below a different portion of edge 1410. A representative first recess 1506 is shown in FIG. 15. In this particular embodiment, a total of 4 substantially-similar first recesses are formed below corresponding portions of edge 1410 of top case 1404. In alternate embodiments, a different number of first recesses may be used. Top case 1404 further includes a plurality of second recesses, each of which is formed below a different portion of edge 1410 and each of which is located between a different pair of first recesses. A representative second recess 1502 is shown in FIG. 15. In this particular embodiment, a total of 4 substantially-similar second recesses are formed below corresponding portions of edge 1410 of top case 1404. In alternate embodiments, a different number of second recesses may be used. Extending downward (i.e., toward an internal cavity of game controller 1400) from top case 1404 into each second recess is a stud. A representative stud 1504 is shown in FIG. 15.

As further shown in FIGS. 14 and 15, thumbstick interface ring 1402 comprises a ring-shaped body 1412 that surrounds or defines an opening. Body 1412 is sized to fit closely within a space defined by edge 1410 of top case 1404 around aperture 1408. Ring 1402 also comprises a plurality of semicircular projecting edge elements that are connected to body 1412 and that extend below body 1412 and away from a center of the opening defined by body 1412. A representative projecting edge element 1508 is shown in FIG. 15. In this particular embodiment, a total of 4 substantially-similar projecting edge elements are connected to and extend from body 1412. In alternate embodiments, a different number of projecting edge elements may be used. Ring 1402 also comprises a plurality of projecting tabs that are connected to body 1412 and that extend below body 1412 and away from the center of the opening defined by body 1412. Each projecting tab is located between a different pair of projecting edge elements. A representative projecting tab 1510 is shown in FIG. 15. In this particular embodiment, a total of 4 substantially-similar projecting tabs are connected to and extend from body 1412. In alternate embodiments, a different number of projecting tabs may be used. Each projecting tab comprises a hole that extends from a first surface thereof to an opposing surface thereof.

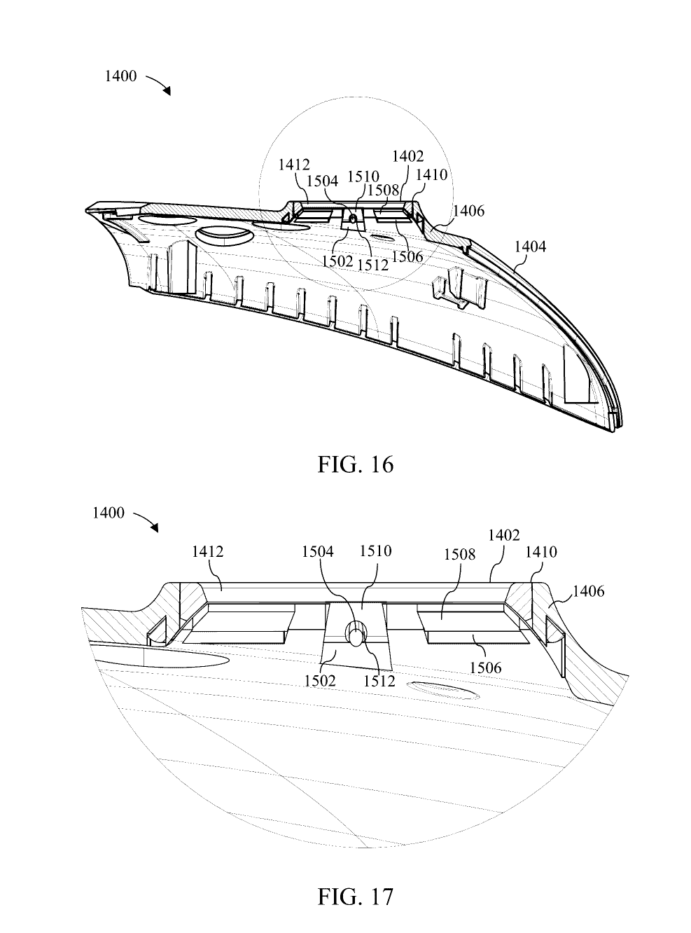

During manufacturing, ring 1402 is placed beneath aperture 1408 such that the studs extending from top case 1404 are aligned with the holes in the projecting tabs connected to body 1412 of ring 1402. After this, upward pressure is applied to ring 1402. Such upward pressure causes each of projecting tabs of ring 1402 to slide into a corresponding second recess of top case 1404, such that each of the studs of top case 1404 will slide into a hole in a corresponding one of the projecting tabs. Also, each of the projecting edge elements of ring 1402 will slide into a corresponding first recess of top case 1404. This configuration is shown in FIG. 16, which shows a cross-sectional view of a portion of game controller 1400, and in FIG. 17, which shows an expanded view of a portion of the cross-sectional view of FIG. 16.

When ring 1402 is fit to top case 1404 in the aforementioned manner, an end of each stud of top case 1404 will extend through a corresponding hole formed in a projecting tab of ring 1402 so that it is exposed beneath the projecting tab. For example, as can be seen in FIGS. 16 and 17, an end of stud 1504 extends through hole 1512 so that it is exposed beneath projecting tab 1510, due to the insertion of projecting tab 1510 into second recess 1502. When such a configuration has been achieved, heat may then applied to the exposed end of each stud. Such heat may be applied, for example, by applying a heated thermal tip of a heat staking machine to the exposed end of each stud. It is assumed for the purposes of this embodiment that the studs are formed from plastic. The application of heat to the ends of the plastic studs increases the malleability of the ends of the plastic studs. A mechanical force is applied to the heated ends that causes each end to deform to form a head. The head that is formed on each stud is wider than the hole through which the stud has been fitted. When the heads cool, they serve to mechanically lock ring 1402 to top case 1404.

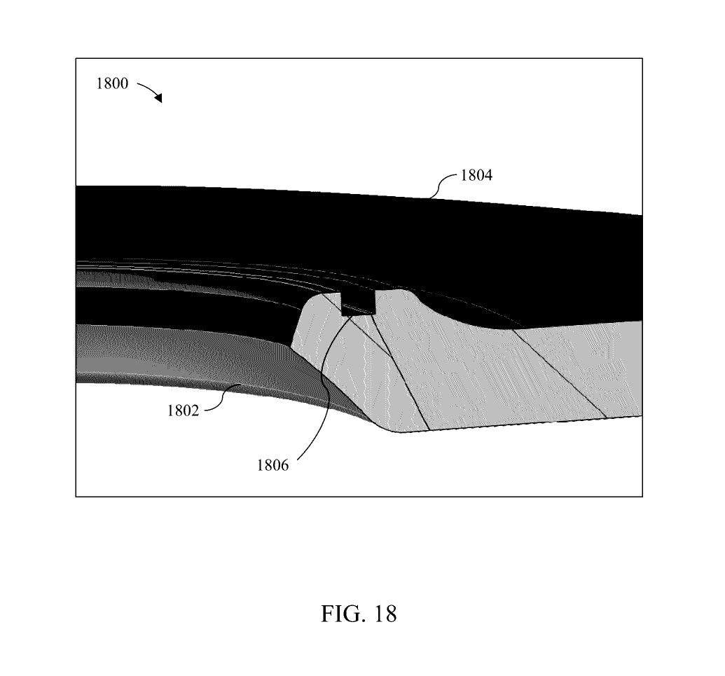

Still other techniques may be used to connect a thumbstick interface ring to a game controller in accordance with various embodiments. For example, FIG. 18 shows a perspective cross-sectional view of a portion of a game controller 1800 in which a thumbstick interface ring 1802 is joined to a top case 1804 of a game controller 1800 via a two-shot injection molding process. In accordance with such an embodiment, a first material may be injected into a mold to form top case 1804. Once top case 1804 is formed, a second material may be injected into the mold to form thumbstick interface ring 1802. The first and second materials are compatible (i.e., chemically similar), such that thumbstick interface 1802 chemically bonds to top case 1804. In an alternate implementation, the order in which the components are formed may be reversed.

As shown in FIG. 18, thumbstick interface ring 1802 may be molded such that it defines a notch 1806 when it is joined to top case 1804. Such notch 1806 may advantageously utilized to hold a masking fixture that can be used to prevent paint from being deposited on the edge of the thumbstick aperture during manufacturing.

A similar design to that shown in FIG. 18 may be achieved by using insert molding. As will be appreciated by persons skilled in the relevant art(s), insert molding is the process of molding or forming plastic parts around other parts, or inserts. Still other techniques that may be used to join a thumbstick interface ring to a housing of a game controller include the use of glue and ultrasonic welding. However, these examples are not intended to be limiting and any suitable method for joining components during manufacturing may be utilized.

The foregoing example game controllers and associated thumbstick interface rings have been presented herein by way of example only and are not intended to be limiting. For example, although in the above-described game controllers, the thumbstick apertures are surrounded by a generally conical or volcano-shaped portion of the housing (e.g., generally conical or volcano-shaped portion 232 of top case 250), the concepts described herein are equally applicable to game controllers in which the thumbstick apertures are surrounded by game controller housing portions having shapes other than conical or volcano-shaped (e.g., a housing portion having a generally flat shape). As another example, in the above-described example game controllers, each thumbstick interface ring surrounds a single thumbstick. However, in accordance with alternate embodiments, a thumbstick interface ring may be used that surrounds two or more thumbsticks that extend from a game controller housing via an aperture thereof.

Furthermore, the concepts described herein are not limited to game controllers of the type shown (e.g., gamepad type controllers that are designed to be held in two hands) but are equally applicable to any type of game controller that includes a user-manipulable thumbstick or joystick. Furthermore, the concepts described herein apply to game controllers that are separate from a computer, video game console, or other platform that they are designed to interact with as well as to game controllers that are integrated with such platforms (e.g., game controllers that form an integrated part of a handheld gaming console).

Additionally, the concepts described herein are not limited to game controllers but are equally applicable to any type of user input device that utilizes joystick-type technology, including but by no means limited to user input devices for cockpit flight controls, remotely controlled aircraft, vehicles, robots, and toys, and industrial and manufacturing applications such as cranes, assembly lines, forestry equipment, mining trucks, and excavators.

Also, as used herein, the term “ring” is to be broadly construed to encompass any component that surrounds (i.e., rings) another component. The term “ring” is not intended to be limited to components that are circular in shape. Indeed, a thumbstick interface ring in accordance with an embodiment may comprise have a body that surrounds an opening wherein the body is shaped like a triangle, square, rectangle, or other polygon, is shaped like an oval, or has an irregular shape.

Furthermore, although some embodiments described herein utilize a thumbstick interface ring that has a relatively low coefficient of friction with a portion of a thumbstick with which the ring interacts, the concepts described herein are not limited to low-friction thumbstick interface rings. Indeed, a thumbstick interface ring may be utilized that provides a high degree of friction, or any other of a wide variety of material properties, as desired.

### III. Additional Exemplary Embodiments

A user input device is described herein that includes a housing, a thumbstick module, a thumbstick cap and a ring. The housing defines an internal cavity of the user input device and includes an aperture. The thumbstick module is disposed within the internal cavity. The thumbstick cap is mounted upon a moveable post of the thumbstick module and extends from the internal cavity and outside the housing through the aperture. The thumbstick cap is manipulable by a user. The ring is connected to the housing around the aperture and impedes contact between a portion of the thumbstick cap and an edge of the housing that surrounds the aperture. The portion of the thumbstick cap is formed from a first material and the ring is formed from a second material that has a coefficient of friction with the first material that is less than a coefficient of friction between the first material and a material from which the housing is formed.

In an embodiment of the foregoing user input device, the second material has a coefficient of kinetic friction with the first material of less than 0.4 per ASTM D1894.

In one embodiment of the foregoing user input device, a wear factor between the first material and the second material is less than 200 (mm³/N m)10⁻⁸ tested per thrust washer ASTM D3702.

In another embodiment of the foregoing user input device, the first material comprises a plastic. In further accordance with such an embodiment, the second material may comprise a metal.

In yet another embodiment of the foregoing user input device, the ring is removably connected to the housing such that a user can disconnect the ring from the housing and reconnect the ring to the housing without damaging the ring or the housing.

In still another embodiment of the foregoing user input device, the ring comprises a body that surrounds an opening and a plurality of studs connected to the body and the housing further comprises a plurality of holes. In further accordance with such an embodiment, each of the plurality of studs extends through a corresponding one of the plurality of holes and has an end deformed through heat staking that locks the stud to the housing.

In a further embodiment of the foregoing user input device, the ring comprises a body that surrounds an opening and a plurality of tabs connected to the body, each of the plurality of tabs including a hole. In further accordance with such an embodiment, the housing further comprises a plurality of studs and each of the plurality of studs extends through a hole in a corresponding one of the plurality of tabs and has an end deformed through heat staking that locks the stud to the ring.

In a still further embodiment of the foregoing user input device, the ring is joined to the housing via a multi-shot molding process.

In another embodiment of the foregoing user input device, the ring is joined to the housing via an insert molding process.

In yet another embodiment of the foregoing user input device, the ring is glued to the housing.

In still another embodiment of the foregoing user input device, the ring is ultrasonically welded to the housing.

A further embodiment of the foregoing user input device includes a second thumbstick module and a second thumbstick cap. The second thumbstick module is disposed within the internal cavity. The second thumbstick cap is mounted upon a moveable post of the second thumbstick module and extends from the internal cavity and outside the housing through the aperture. The second thumbstick cap is manipulable by the user. In accordance with this embodiment, the ring further impedes contact between a portion of the second thumbstick cap and the edge of the housing that surrounds the aperture.

Another user input device is described herein that includes a housing, a thumbstick module, a thumbstick cap and a ring. The housing defines an internal cavity of the user input device and includes an aperture. The thumbstick module is disposed within the internal cavity. The thumbstick cap is mounted upon a moveable post of the thumbstick module and extends from the internal cavity and outside the housing through the aperture. The thumbstick cap is manipulable by a user. The ring is removably connected to the housing around the aperture and impedes contact between a portion of the thumbstick cap and an edge of the housing that surrounds the aperture. The removable connection between the ring and the housing enables a user to disconnect the ring from the housing and reconnect the ring to the housing without damaging the ring or the housing.

In one embodiment of the foregoing user input device, the ring comprises a body that surrounds an opening and one or more first mating elements connected to the body, the housing comprises one or more second mating elements, each of the one or more second mating elements corresponding to one of the first mating elements, and the one or more first mating elements are adapted to be removably connected to the one or more corresponding second mating elements.

In further accordance with such an embodiment, the one or more first mating elements may comprise a plurality of elastically-deformable hooks and the one or more second mating elements may comprise a plurality of recesses in the housing, each of the plurality of recesses being adapted to catch a corresponding one of the plurality of elastically-deformable hooks. Alternatively, each first mating element may comprise a threaded ring and each second mating element may comprise a threaded socket. As another alternative, each first mating element may comprise a quarter-turn fastener and each second mating element may comprise a mating socket for the quarter-turn fastener.

In another embodiment of the foregoing user input device, the portion of the thumbstick cap is formed from a first material and the ring is formed from a second material that has a coefficient of friction with the first material that is less than a coefficient of friction between the first material and a material from which the housing is formed.

Yet another user input device is described herein that includes a housing, a thumbstick module, a thumbstick cap and one or more first mating elements. The housing defines an internal cavity of the user input device and includes an aperture. The thumbstick module is disposed within the internal cavity. The thumbstick cap is mounted upon a moveable post of the thumbstick module and extends from the internal cavity and outside the housing through the aperture. The thumbstick cap is manipulable by a user. The one or more first mating elements are configured to removably connect to one or more second mating elements of a ring. The removable connection of the one or more first mating elements to the one or more second mating elements enables the ring to be removably connected to the housing around the aperture and to impede contact between a portion of the thumbstick cap and an edge of the housing that surrounds the aperture.

An accessory for a user input device is also described herein. The accessory comprises a ring. The ring includes a body that surrounds an opening and one or more first mating elements connected to the body. The one or more first mating elements are adapted to mate with one or more corresponding second mating elements included in a housing of the user input device and located proximate to an edge of the housing that surrounds an aperture defined in the housing. The first and second mating elements are configured to enable the ring to be removably connected to the housing. The ring is adapted to impede contact between the edge of the housing and a portion of a user-manipulable thumbstick of the user input device that extends through the aperture.

In one embodiment of the foregoing accessory, the ring is formed from a first material and the portion of the user-manipulable thumbstick is formed from a second material that has a coefficient of kinetic friction with the first material of less than 0.4 per ASTM D1894.

In another embodiment of the foregoing accessory, the ring is formed from a first material, the portion of the user-manipulable thumbstick is formed from a second material, and a wear factor between the first material and the second material is less than 200 (mm3/N m) 10-8 tested per thrust washer ASTM D3702.

In yet another embodiment of the foregoing accessory, the ring is formed from a first material and the portion of the user-manipulable thumbstick is formed from a second material that has a coefficient of friction with the first material that is less than a coefficient of friction between the first material and a material from which the housing is formed.

In still another embodiment of the foregoing accessory, the ring is formed from a plastic. In further accordance with such an embodiment, the portion of the user-manipulable thumbstick may be formed from a metal.

In a further embodiment of the foregoing accessory of claim 1, the one or more first mating elements comprise a plurality of elastically-deformable hooks and the one or more second mating elements comprise a plurality of recesses in the housing, each of the plurality of recesses being adapted to catch a corresponding one of the plurality of elastically-deformable hooks.

In a still further embodiment of the foregoing accessory, the one or more first mating elements each comprises a threaded ring and the one or more second mating elements each comprises a threaded socket.

In another embodiment of the foregoing accessory, the one or more first mating elements each comprises a quarter-turn fastener and the one or more second mating elements each comprises a mating socket for the quarter-turn fastener.

In yet another embodiment of the foregoing accessory, each of the one or more first mating elements is configured to be fastened to a corresponding one of the second mating elements via an interference fit.

In still another embodiment of the foregoing accessory, the body is shaped like one of a circle, an oval, or a polygon.

A user-removable and user-attachable thumbstick interface ring for a game controller is also described herein. The thumbstick interface ring comprises a body that surrounds an opening and one or more first mating elements connected to the body. The one or more first mating elements are adapted to mate with one or more corresponding second mating elements included in a housing of the game controller and located proximate to an edge of the housing that surrounds an aperture defined in the housing. The first and second mating elements are configured to enable the thumbstick interface ring to be removably connected to the housing. The thumbstick interface ring is configured to impede contact between the edge of the housing and a portion of a user-manipulable thumbstick of the game controller that projects through the aperture.

In one embodiment of the foregoing thumbstick interface ring, the thumbstick interface ring is formed from a first material and the portion of the user-manipulable thumbstick is formed from a second material that has a coefficient of kinetic friction with the first material of less than 0.4 per ASTM D1894.

In another embodiment of the foregoing thumbstick interface ring, the ring is formed from a first material and the portion of the user-manipulable thumbstick is formed from a second material that has a coefficient of friction with the first material that is less than a coefficient of friction between the first material and a material from which the housing is formed.

In yet another embodiment of the foregoing thumbstick interface ring, the one or more first mating elements comprise a plurality of elastically-deformable hooks and the one or more second mating elements comprise a plurality of recesses in the housing, each of the plurality of recesses being adapted to catch a corresponding one of the plurality of elastically-deformable hooks.

In still another embodiment of the foregoing thumbstick interface ring, the one or more first mating elements each comprises a threaded ring and the one or more second mating elements each comprises a threaded socket.

In a further embodiment of the foregoing thumbstick interface ring, the one or more first mating elements each comprises a quarter-turn fastener and wherein the one or more second mating elements each comprises a mating socket for the quarter-turn fastener.

In a still further embodiment of the foregoing thumbstick interface ring, each of the one or more first mating elements is configured to be fastened to a corresponding one of the one second mating elements via an interference fit.

In another embodiment of the foregoing thumbstick interface ring, the body is shaped like one of a circle, an oval, or a polygon.

A thumbstick interface component for a game controller is also described herein. The thumbstick interface component comprises a body that surrounds an opening and one or more first mating elements connected to the body. The one or more first mating elements are adapted to mate with one or more corresponding second mating elements included in a housing of the game controller and located proximate to an edge of the housing that surrounds an aperture defined in the housing. The first and second mating elements are configured to enable the thumbstick interface ring to be removably connected to the housing. The thumbstick interface ring is configured to impede contact between the edge of the housing and a portion of a user-manipulable thumbstick of the game controller that projects through the aperture.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A user input device, comprising:
a housing that defines an internal cavity of the user input device and includes an aperture;
a thumbstick module that is disposed within the internal cavity;
a thumbstick cap that is mounted upon a moveable post of the thumbstick module and that extends from the internal cavity and outside the housing through the aperture, the thumbstick cap being manipulable by a user; and
a ring that is connected to the housing around the aperture and that impedes contact between a portion of the thumbstick cap and an edge of the housing that surrounds the aperture, the portion of the thumbstick cap being formed from a first material and the ring being formed from a second material that has a coefficient of friction with the first material that is less than a coefficient of friction between the first material and a material from which the housing is formed.

2. The user input device of claim 1, wherein the second material has a coefficient of kinetic friction with the first material of less than 0.4 per ASTM D1894.

3. The user input device of claim 1, wherein a wear factor between the first material and the second material is less than 200 (mm³/N m)10⁻⁸ tested per thrust washer ASTM D3702.

4. The user input device of claim 1, wherein the first material comprises a plastic.

5. The user input device of claim 4, wherein the second material comprises a metal.

6. The user input device of claim 1, wherein the ring is removably connected to the housing such that a user can disconnect the ring from the housing and reconnect the ring to the housing without damaging the ring or the housing.

7. The user input device of claim 1,
wherein the ring comprises
a body that surrounds an opening and
a plurality of studs connected to the body;
wherein the housing further comprises a plurality of holes; and
wherein each of the plurality of studs extends through a corresponding one of the plurality of holes and has an end deformed through heat staking that locks the stud to the housing.

8. The user input device of claim 1,
wherein the ring comprises
a body that surrounds an opening and
a plurality of tabs connected to the body, each of the plurality of tabs including a hole;
wherein the housing further comprises a plurality of studs; and
wherein each of the plurality of studs extends through a hole in a corresponding one of the plurality of tabs and has an end deformed through heat staking that locks the stud to the ring.

9. The user input device of claim 1, wherein the ring is joined to the housing via a multi-shot molding process.

10. The user input device of claim 1, wherein the ring is joined to housing via an insert molding process.

11. The user input device of claim 1, wherein the ring is glued to the housing.

12. The user input device of claim 1, wherein the ring is ultrasonically welded to the housing.

13. The user input device of claim 1, further comprising:
a second thumbstick module that is disposed within the internal cavity; and
a second thumbstick cap that is mounted upon a moveable post of the second thumbstick module and that extends from the internal cavity and outside the housing through the aperture, the second thumbstick cap being manipulable by the user;
wherein the ring further impedes contact between a portion of the second thumbstick cap and the edge of the housing that surrounds the aperture.

14. A user input device, comprising:
a housing that defines an internal cavity of the user input device and includes an aperture;
a thumbstick module that is disposed within the internal cavity;
a thumbstick cap that is mounted upon a moveable post of the thumbstick module and that extends from the internal cavity and outside the housing through the aperture, the thumbstick cap being manipulable by a user; and
a ring that is removably connected to the housing around the aperture and that impedes contact between a portion of the thumbstick cap and an edge of the housing that surrounds the aperture, the removable connection between the ring and the housing enabling a user to disconnect the ring from the housing and reconnect the ring to the housing without damaging the ring or the housing.

15. The user input device of claim 14,
wherein the ring comprises
a body that surrounds an opening and
one or more first mating elements connected to the body;
wherein the housing comprises one or more second mating elements, each of the one or more second mating elements corresponding to one of the first mating elements; and
wherein the one or more first mating elements are adapted to be removably connected to the one or more corresponding second mating elements.

16. The user input device of claim 15, wherein the one or more first mating elements comprise a plurality of elastically-deformable hooks and wherein the one or more second mating elements comprise a plurality of recesses in the housing, each of the plurality of recesses being adapted to catch a corresponding one of the plurality of elastically-deformable hooks.

17. The user input device of claim 15, wherein each first mating element comprises a threaded ring and each second mating element comprises a threaded socket.

18. The user input device of claim 15, wherein each first mating element comprises a quarter-turn fastener and wherein each second mating element comprises a mating socket for the quarter-turn fastener.

19. The user input device of claim 14, wherein the portion of the thumbstick cap is formed from a first material and the ring is formed from a second material that has a coefficient of friction with the first material that is less than a coefficient of friction between the first material and a material from which the housing is formed.

20. A user input device, comprising:
a housing that defines an internal cavity of the user input device and includes an aperture;
a thumbstick module that is disposed within the internal cavity;
a thumbstick cap that is mounted upon a moveable post of the thumbstick module and that extends from the internal cavity and outside the housing through the aperture, the thumbstick cap being manipulable by a user; and
one or more first mating elements, the one or more first mating elements being configured to removably connect to one or more second mating elements of a ring, the removable connection of the one or more first mating elements to the one or more second mating elements enabling the ring to be removably connected to the housing around the aperture and to impede contact between a portion of the thumbstick cap and an edge of the housing that surrounds the aperture.
